(19) United States
(12) Patent Application Publication
(10) Pub. No.: US 2023/0239549 A1
(43) Pub. Date: Jul. 27, 2023

(54) SYSTEMS AND METHODS FOR DATA STORAGE AND RETRIEVAL

(71) Applicant: ZHEJIANG DAHUA TECHNOLOGY CO., LTD., Hangzhou (CN)

(72) Inventors: Xin LUO, Hangzhou (CN); Wenlong JIANG, Hangzhou (CN)

(73) Assignee: ZHEJIANG DAHUA TECHNOLOGY CO., LTD., Hangzhou (CN)

(21) Appl. No.: 18/190,109

(22) Filed: Mar. 26, 2023

Related U.S. Application Data
(63) Continuation of application No. PCT/CN2021/125071, filed on Oct. 20, 2021.

(30) Foreign Application Priority Data
Oct. 20, 2020 (CN) 202011126421.0

(51) Int. Cl. H04N 21/845; H04N 21/84

(52) U.S. Cl. CPC H04N 21/8456; H04N 21/84

(57) ABSTRACT

The present disclosure is related to systems and methods for storing data. The method includes obtaining a streaming data file including a first set of data frames. The method includes, in response to determining that the streaming data file satisfies one or more conditions, generating a hole frame storing an offset address of the streaming data file, and establishing a target streaming data file by adding a second set of data frames into the streaming data file based on the hole frame.

### CROSS-REFERENCE TO RELATED APPLICATIONS

This application is a Continuation of International Application No. PCT/CN2021/125071, filed on Oct. 20, 2021, which claims priority to Chinese Patent Application No. 202011126421.0, filed on Oct. 20, 2020, the contents of each of which are incorporated herein by reference.

### TECHNICAL FIELD

This present disclosure generally relates to data technology, and in particular, to systems and methods for data storage and retrieval.

### BACKGROUND

Data storage systems are widely used in various fields, such as video surveillance fields (e.g., a security protection service). For example, video data may be streaming data that is continuously generated, and a data file including a plurality of data frames is established every preset time period. Conventionally, when a video is frequently interrupted due to network interruption or other reasons, a large number of data files may be generated, and the amount of data in each data file may be small. Usually, it is difficult to manage a large number of data files, which may affect the performance of the data storage system. In addition, it is also difficult to retrieve data from a large number of data files stored in the data storage system. Therefore, it is desirable to provide systems and methods for storing data and retrieving data efficiently.

### SUMMARY

According to an aspect of the present disclosure, a system for storing data may include at least one storage device configured to store a set of program instructions, and at least one processor coupled to the at least one storage device. The at least one processor may be configured to execute the program instructions, which may cause the system to perform a method. The method may include obtaining a streaming data file including a first set of data frames. The method may include, in response to determining that the streaming data file satisfies one or more conditions, generating a hole frame storing an offset address of the streaming data file. The method may include establishing a target streaming data file by adding a second set of data frames into the streaming data file based on the hole frame.

In some embodiments, the one or more conditions may include a first condition. The method may include, in response to determining that the streaming data file satisfies the first condition, adding a first total index and a first description of the streaming data file at an end of the streaming data file.

In some embodiments, the steaming data file may satisfy the first condition in response to determining that the streaming data file is closed.

In some embodiments, the one or more conditions may include a second condition. The method may include, in response to determining that the streaming data file satisfies the second condition, adding the hole frame after the first file description in the streaming data file. The method may include adding at least one index after the hole frame according to at least one time period. The at least one index may store at least one of index information of a target frame in the second set of data frames, or an offset address of the hole frame in the target streaming data file.

In some embodiments, the at least one index may include a primary index and a secondary index. The at least one time period may include a first time period corresponding to the secondary index, and a second time period corresponding to the primary index. The first time period may be less than the second preset time period. The method may include adding at least one secondary index after the hole frame according to the first preset time period. The at least one secondary index may store the index information of the target frame in the second set of data frames, and an offset address of a previous primary index added prior to the at least one secondary index. The method may include adding at least one primary index after the hole frame according to the second time period. The at least one primary index may store at least one offset address of at least one previous secondary index added prior to the at least one primary index, and the offset address of the hole frame in the target streaming data file.

In some embodiments, a preset number of secondary indexes in the at least one secondary index after the hole frame may store the offset address of the hole frame in the streaming data file.

In some embodiments, the steaming data file may satisfy the second condition in response to determining that the streaming data file is opened after the streaming data file is closed, and a storage time of the streaming data file is less than a time threshold.

In some embodiments, the method may include, in response to determining that the target streaming data file satisfies the first condition, adding a second total index and a second description of the target streaming data file at an end of the target streaming data file. The second total index may store index information of a target frame in the second set of data frames, and the offset address of the hole frame in the target streaming data file.

According to another aspect of the present disclosure, a system for storing data may include at least one storage device configured to store a set of program instructions, and at least one processor coupled to the at least one storage device. The at least one processor may be configured to execute the program instructions, which may cause the system to perform a method. The method may include obtaining a first streaming data file including a first set of data frames. The method may include, in response to determining that the first streaming data file satisfies one or more conditions, generating a hole frame storing an offset address of the first streaming data file. The method may include establishing a second streaming data file including a second set of data frames. The method may include generating a target streaming data file by adding the second streaming data file into the first streaming data file through the hole frame.

According to another aspect of the present disclosure, a system for retrieving data may include at least one storage device configured to store a set of program instructions, and at least one processor coupled to the at least one storage device. The at least one processor may be configured to execute the program instructions, which may cause the system to perform a method. The method may include obtaining a target streaming data file including a plurality of sets of data frames and a plurality of hole frames. Each of the plurality of hole frames may be between adjacent sets of data frames. The method may include, in response to determining that the target streaming data file satisfies a condition, obtaining a first total index of a first set of data frames at an end of the target streaming data file. The first total index may store an offset address of a first hole frame corresponding to the first set of data frames. The method may include obtaining the first hole frame based on the offset address of the first hole frame. The first hole frame may store an offset address of a second total index of a second set of data frames. The second set of data frames may be prior to the first set of data frames in time. The method may include obtaining the second total index of the second set of data frames based on the offset address of the second total index.

In some embodiments, the target steaming data file may satisfy the condition in response to determining that no data is added into the target streaming data file.

In some embodiments, the method may include, in response to determining that the target streaming data file does not satisfy the condition, obtaining a target index corresponding to a target position in the first set of data frames. The method may include obtaining the first hole frame based on the target index. The first hole frame may store the offset address of the second total index of the second set of data frames. The method may include obtaining the second total index of the second set of data frames based on the offset address of the second total index.

In some embodiments, the target index may be a secondary index. The method may include obtaining the offset address of the first hole frame corresponding to the first set of data frames based on the secondary index corresponding to the target position in the first set of data frames.

In some embodiments, the method may include obtaining a primary index corresponding to the target position based on the secondary index corresponding to the target position in the first set of data frames. The method may include obtaining the offset address of the first hole frame corresponding to the first set of data frames based on the primary index corresponding to the target position.

According to another aspect of the present disclosure, a method for storing data may be implemented on a computing device having at least one processor and at least one storage device. The method may include obtaining a streaming data file including a first set of data frames. The method may include, in response to determining that the streaming data file satisfies one or more conditions, generating a hole frame storing an offset address of the streaming data file. The method may include establishing a target streaming data file by adding a second set of data frames into the streaming data file based on the hole frame.

According to another aspect of the present disclosure, a method for storing data may be implemented on a computing device having at least one processor and at least one storage device. The method may include obtaining a first streaming data file including a first set of data frames. The method may include, in response to determining that the first streaming data file satisfies one or more conditions, generating a hole frame storing an offset address of the first streaming data file. The method may include establishing a second streaming data file including a second set of data frames. The method may include generating a target streaming data file by adding the second streaming data file into the first streaming data file through the hole frame.

According to another aspect of the present disclosure, a method for retrieving data may be implemented on a computing device having at least one processor and at least one storage device. The method may include obtaining a target streaming data file including a plurality of sets of data frames and a plurality of hole frames. Each of the plurality of hole frames may be between adjacent sets of data frames. The method may include, in response to determining that the target streaming data file satisfies a condition, obtaining a first total index of a first set of data frames at an end of the target streaming data file. The first total index may store an offset address of a first hole frame corresponding to the first set of data frames. The method may include obtaining the first hole frame based on the offset address of the first hole frame. The first hole frame may store an offset address of a second total index of a second set of data frames. The second set of data frames may be prior to the first set of data frames in time. The method may include obtaining the second total index of the second set of data frames based on the offset address of the second total index.

According to still another aspect of the present disclosure, a non-transitory computer readable medium may include at least one set of program instructions. When executed by at least one processor of a computing device, the at least one set of program instructions may cause the at least one processor to effectuate a method. The method may include obtaining a streaming data file including a first set of data frames. The method may include, in response to determining that the streaming data file satisfies one or more conditions, generating a hole frame storing an offset address of the streaming data file. The method may include establishing a target streaming data file by adding a second set of data frames into the streaming data file based on the hole frame.

According to still another aspect of the present disclosure, a non-transitory computer readable medium may include at least one set of program instructions. When executed by at least one processor of a computing device, the at least one set of program instructions may cause the at least one processor to effectuate a method. The method may include obtaining a first streaming data file including a first set of data frames. The method may include, in response to determining that the first streaming data file satisfies one or more conditions, generating a hole frame storing an offset address of the first streaming data file. The method may include establishing a second streaming data file including a second set of data frames. The method may include generating a target streaming data file by adding the second streaming data file into the first streaming data file through the hole frame.

According to still another aspect of the present disclosure, a non-transitory computer readable medium may include at least one set of program instructions. When executed by at least one processor of a computing device, the at least one set of program instructions may cause the at least one processor to effectuate a method. The method may include obtaining a target streaming data file including a plurality of sets of data frames and a plurality of hole frames. Each of the plurality of hole frames may be between adjacent sets of data frames. The method may include, in response to determining that the target streaming data file satisfies a condition, obtaining a first total index of a first set of data frames at an end of the target streaming data file. The first total index may store an offset address of a first hole frame corresponding to the first set of data frames. The method may include obtaining the first hole frame based on the offset address of the first hole frame. The first hole frame may store an offset address of a second total index of a second set of data frames. The second set of data frames may be prior to the first set of data frames in time. The method may include obtaining the second total index of the second set of data frames based on the offset address of the second total index.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary data system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which a terminal device may be implemented according to some embodiments of the present disclosure;

FIG. 4A is a block diagram illustrating an exemplary processing device according to some embodiments of the present disclosure;

FIG. 4B is a block diagram illustrating an exemplary storing module according to some embodiments of the present disclosure;

FIG. 4C is a block diagram illustrating an exemplary retrieving module according to some embodiments of the present disclosure;

FIG. 5 is a flowchart illustrating an exemplary process for storing data according to some embodiments of the present disclosure;

FIG. 6 is a flowchart illustrating an exemplary process for storing data according to some embodiments of the present disclosure;

FIG. 7 is a flowchart illustrating an exemplary process for storing data according to some embodiments of the present disclosure;

FIG. 8 is a flowchart illustrating an exemplary process for retrieving data according to some embodiments of the present disclosure; and

FIGS. 9-11 are schematic diagrams illustrating exemplary processes for storing data according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

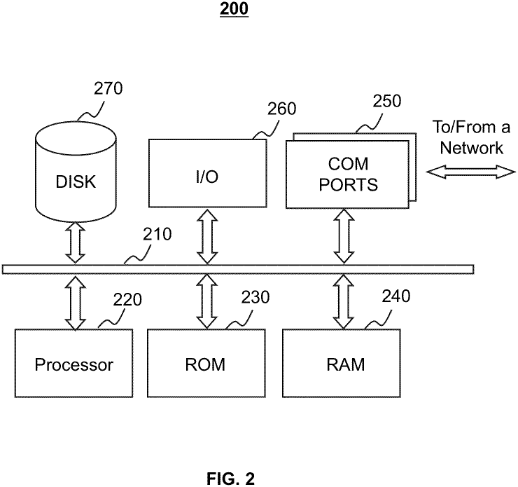

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 220 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/subunits/sub-blocks despite their physical organization or storage. The description may be applicable to a system, an engine, or a portion thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for storing data. According to some systems and methods of the present disclosure, a processing device may obtain a streaming data file including a first set of data frames. In response to determining that the streaming data file satisfies one or more conditions, the processing device may generate a hole frame storing an offset address of the streaming data file. In some embodiments, the steaming data file may satisfy the one or more conditions in response to determining that the first set of data frames in the streaming data file is not continuous with a second set of data frames to be added into the streaming data file. For example, the steaming data file may satisfy the one or more conditions in response to determining that the streaming data file is closed, the streaming data file is then reopened, and a storage time of the streaming data file is less than a time threshold. The processing device may establish a target streaming data file by adding the second set of data frames into the streaming data file based on the hole frame.

According to some embodiments of the present disclosure, when a video is interrupted due to network jitter or other reasons, data frames (e.g., the first set of data frames) generated before video interruption, and data frames (e.g., the second set of data frames) generated after video recovery may be added into a same target streaming data file based on a hole frame. Therefore, there is no need to establish a plurality of small streaming data files, which may reduce data management pressure of a data system (e.g., a cloud storage system).

Another aspect of the present disclosure relates to systems and methods for storing data. According to some systems and methods of the present disclosure, a processing device may obtain a first streaming data file including a first set of data frames. In response to determining that the first streaming data file satisfies one or more conditions, the processing device may generate a hole frame storing an offset address of the first streaming data file. The processing device may establish a second streaming data file including a second set of data frames. The processing device may generate a target streaming data file by adding the second streaming data file into the first streaming data file through the hole frame.

Accordingly, by combining a plurality of streaming data files generated by frequent file switching (e.g., caused by network jitter) into the target streaming data file based on at least one hole frame, a total number of streaming data files may be reduced, and data management pressure of a data system (e.g., a cloud storage system) may be reduced. Furthermore, the read and write performance (e.g., speed, accuracy) of a continuous streaming data file (e.g., the target streaming data file) may be higher than that of a plurality of small streaming data files.

Another aspect of the present disclosure relates to systems and methods for retrieving data. According to some systems and methods of the present disclosure, a processing device may obtain a target streaming data file including a plurality of sets of data frames and a plurality of hole frames. Each of the plurality of hole frames may be between adjacent sets of data frames. In response to determining that the target streaming data file satisfies a condition, the processing device may obtain a first total index of a first set of data frames at an end of the target streaming data file. The first total index may store an offset address of a first hole frame corresponding to the first set of data frames. The processing device may obtain the first hole frame based on the offset address of the first hole frame. The first hole frame may store an offset address of a second total index of a second set of data frames. The second set of data frames may be prior to the first set of data frames in time. The processing device may obtain the second total index of the second set of data frames based on the offset address of the second total index.

According, by retrieving data based on a plurality of total indexes of a plurality of sets of data frames, and a plurality of hole frames corresponding to the plurality of sets of data frames, the efficiency of data retrieval may be improved.

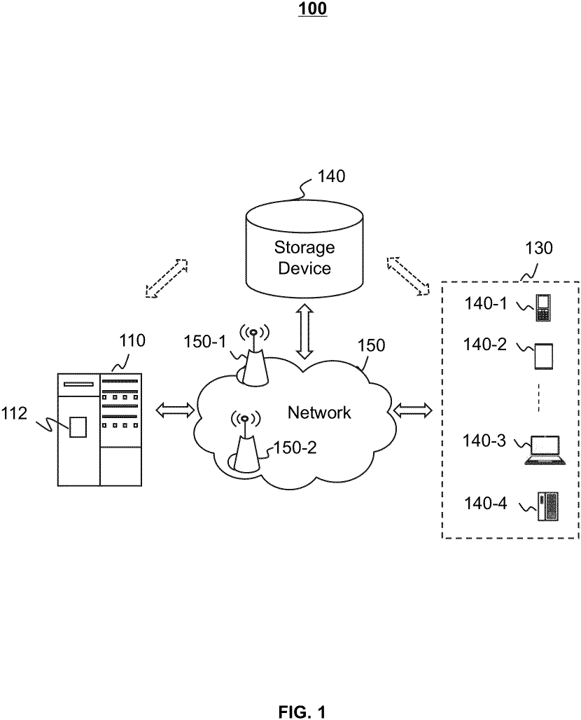

FIG. 1 is a schematic diagram illustrating an exemplary data system according to some embodiments of the present disclosure. In some embodiments, the data system 100 may include a server 110, a terminal device 130, a storage device 140, and a network 150. The components of the data system 100 may be connected to each other in one or more of various ways. Merely by way of example, the terminal device 130 may be connected to the storage device 140 through the network 150, or connected to the storage device 140 directly as illustrated by the bidirectional dotted arrow connecting the terminal device 130 and the storage device 140 in FIG. 1. As still another example, the storage device 140 may be connected to the server 110 through the network 150, or connected to the server 110 directly as illustrated by the bidirectional dotted arrow connecting the storage device 140 and the server 110 in FIG. 1.

In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the terminal device 130, and/or the storage device 140 via the network 150. As another example, the server 110 may be directly connected to the terminal device 130, and/or the storage device 140 to access stored information and/or data. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure. In some embodiments, the server 110 may be integrated into the terminal device 130. In some embodiments, the server 110 may be integrated into the storage device 140.

In some embodiments, the server 110 may include a processing device 112. The processing device 112 may process information and/or data to perform one or more functions described in the present disclosure. For example, the processing device 112 may obtain a streaming data file including a first set of data frames. As another example, in response to determining that a streaming data file satisfies one or more conditions, the processing device 112 may generate a hole frame storing an offset address of the streaming data file. As still another example, the processing device 112 may establish a target streaming data file by adding a second set of data frames into a streaming data file based on a hole frame. As still another example, the processing device 112 may establish a second streaming data file including a second set of data frames. As still another example, the processing device 112 may generate a target streaming data file by adding a second streaming data file into a first streaming data file through a hole frame. As still another example, the processing device 112 may obtain a target streaming data file including a plurality of sets of data frames and a plurality of hole frames. As still another example, in response to determining that a target streaming data file satisfies a condition, the processing device 112 may obtain a first total index of a first set of data frames at an end of the target streaming data file. As still another example, the processing device 112 may obtain a first hole frame based on an offset address of a first hole frame. As still another example, the processing device 112 may obtain a second total index of a second set of data frames based on an offset address of the second total index. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 110 may be connected to the network 150 to communicate with one or more components (e.g., the terminal device 130, the storage device 140) of the data system 100. In some embodiments, the server 110 may be directly connected to or communicate with one or more components (e.g., the terminal device 130, the storage device 140) of the data system 100.

In some embodiments, the terminal devices 130 may include a mobile device 130-1, a tablet computer 130-2, a laptop computer 130-3, a telephone 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc.

The storage device 140 may store data and/or instructions. In some embodiments, the storage device 140 may store data obtained from the terminal device 130, the processing device 112, and/or an external storage device. For example, the storage device 140 may store a streaming data file (e.g., a target streaming data file, a first streaming data file, a second streaming data file). In some embodiments, the storage device 140 may store data and/or instructions that the server 110 may execute or use to perform exemplary methods described in the present disclosure. In some embodiments, the storage device 140 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyrisor RAM (T-RAM), a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 110, the terminal device 130) of the data system 100. One or more components of the data system 100 may access the data or instructions stored in the storage device 140 via the network 150. In some embodiments, the storage device 140 may be directly connected to or communicate with one or more components (e.g., the server 110, the terminal device 130) of the data system 100. In some embodiments, the storage device 140 may be part of the server 110. In some embodiments, the storage device 140 may be part of the terminal device 130.

The network 150 may facilitate exchange of information and/or data. In some embodiments, one or more components (e.g., the server 110, the terminal device 130, the storage device 140) of the data system 100 may send information and/or data to other component(s) of the data system 100 via the network 150. For example, the server 110 may obtain/acquire one or more data frames from an image acquisition device (e.g., an infrared imaging device). In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points (e.g., 150-1, 150-2), through which one or more components of the data system 100 may be connected to the network 150 to exchange data and/or information.

It should be noted that the data system 100 is merely provided for the purposes of illustration, and is not intended to limit the scope of the present disclosure. For persons having ordinary skills in the art, multiple variations or modifications may be made under the teachings of the present disclosure. However, those variations and modifications do not depart from the scope of the present disclosure. For example, the data system 100 may further include a database, an information source, etc. As another example, the data system 100 may be implemented on other devices to realize similar or different functions.

In some embodiments, the data system 100 may include an image acquisition device. The image acquisition device may be configured to capture one or more data frames (e.g., a video). In some embodiments, the image acquisition device may include a video camera. In some embodiments, the image acquisition device may include a spherical camera, a hemispherical camera, a rifle camera, etc. In some embodiments, the image acquisition device may include a black-white camera, a color camera, an infrared camera, an X-ray camera, etc. In some embodiments, the image acquisition device may include a digital camera, an analog camera, etc. In some embodiments, the image acquisition device may include a monocular camera, a binocular camera, a multi-camera, etc.

FIG. 2 is a schematic diagram illustrating exemplary hardware and/or software components of an exemplary computing device according to some embodiments of the present disclosure. In some embodiments, the server 110 may be implemented on the computing device 200. For example, the processing device 112 may be implemented on the computing device 200 and configured to perform functions of the processing device 112 disclosed in this disclosure.

The computing device 200 may be used to implement any component of the data system 100 as described herein. For example, the processing device 112 may be implemented on the computing device 200, via its hardware, software program, firmware, or a combination thereof. Although only one such computer is shown, for convenience, the computer functions relating to the data storing and/or data retrieving as described herein may be implemented in a distributed fashion on a number of similar platforms to distribute the processing load.

The computing device 200 may include COM ports 250 connected to and from a network connected thereto to facilitate data communications. The computing device 200 may also include a processor 220, in the form of one or more, e.g., logic circuits, for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, a read only memory (ROM) 230, or a random-access memory (RAM) 240, for storing various data files to be processed and/or transmitted by the computing device 200. The computing device 200 may also include program instructions stored in the ROM 230, the RAM 240, and/or another type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one processor is described in FIG. 2. Multiple processors are also contemplated, thus operations and/or steps performed by one processor as described in the present disclosure may also be jointly or separately performed by the multiple processors. For example, if in the present disclosure the processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

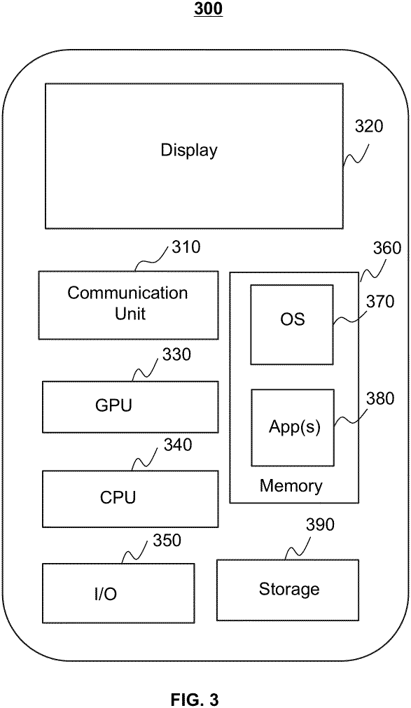

FIG. 3 is a schematic diagram illustrating exemplary hardware and/or software components of an exemplary mobile device on which a terminal device may be implemented according to some embodiments of the present disclosure. In some embodiments, the terminal device 130 may be implemented on the mobile device 300. As illustrated in FIG. 3, the mobile device 300 may include a communication unit 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, Harmony OS, etc.) and one or more applications 380 may be loaded into the memory 360 from the storage 390 in order to be executed by the CPU 340. The applications 380 may include a browser or any other suitable mobile app for receiving and rendering information relating to data storing and/or data retrieving or other information from the data system 100. User interactions with the information stream may be achieved via the I/O 350 and provided to the processing device 112 and/or other components of the data system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

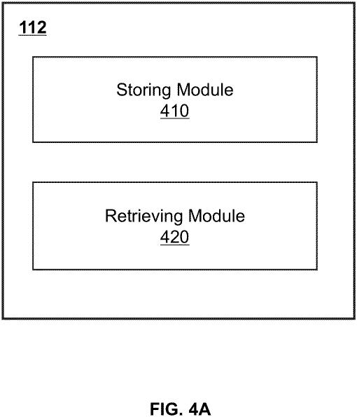

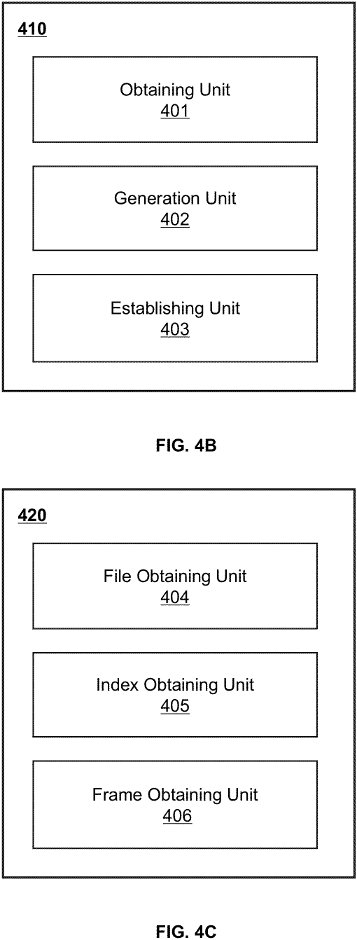

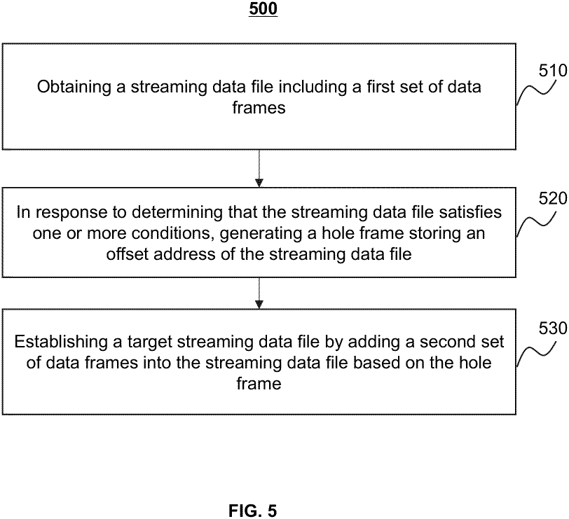

FIG. 4A is a block diagram illustrating an exemplary processing device according to some embodiments of the present disclosure. FIG. 4B is a block diagram illustrating an exemplary storing module according to some embodiments of the present disclosure. FIG. 4C is a block diagram illustrating an exemplary retrieving module according to some embodiments of the present disclosure.

The processing device 112 may include a storing module 410 and a retrieving module 420. The storing module 410 may be configured to store data. In some embodiments, the storing module 410 may include an obtaining unit 401, a generation unit 402, and an establishing unit 403. The retrieving module 420 may be configured to retrieve data. In some embodiments, the retrieving module 420 may include a file obtaining unit 404, an index obtaining unit 405, and a frame obtaining unit 406.

The obtaining unit 401 may be configured to obtain data and/or information associated with the data system 100. The data and/or information associated with the data system 100 may include a streaming data file, a target streaming data file, a first streaming data file, or the like, or any combination thereof. For example, the obtaining unit 401 may obtain a streaming data file including a first set of data frames. In some embodiments, the obtaining unit 401 may obtain the data and/or the information associated with the data system 100 from one or more components (e.g., the terminal device 130, the storage device 140, an image acquisition device) of the data system 100 via the network 150.

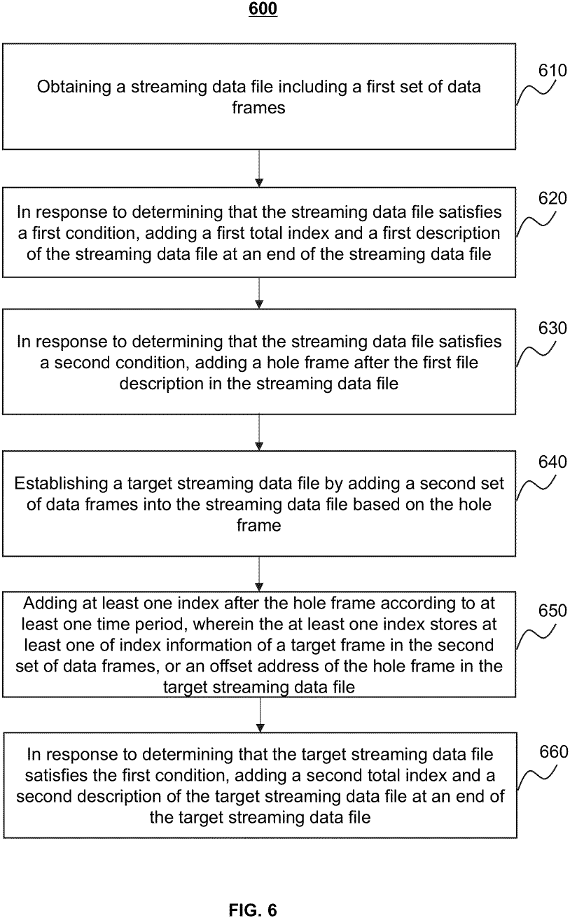

The generation unit 402 may be configured to generate obtain data and/or information associated with the data system 100. In some embodiments, the generation unit 402 may generate a hole frame storing an offset address of a streaming data file. For example, the generation unit 402 may add a hole frame after a first file description in a streaming data file. More descriptions for generating a hole frame may be found elsewhere in the present disclosure (e.g., FIGS. 5-7, 9-11, and descriptions thereof). In some embodiments, the generation unit 402 may add at least one index after a hole frame according to at least one time period. In some embodiments, in response to determining that a streaming data file satisfies a first condition, the generation unit 402 may add a first total index and a first description of the streaming data file at an end of the streaming data file. In some embodiments, in response to determining that a target streaming data file satisfies a first condition, the generation unit 402 may add a second total index and a second description of the target streaming data file at an end of the target streaming data file. More descriptions for adding an index and a description of a streaming data file may be found elsewhere in the present disclosure (e.g., FIGS. 5-7, 9-11, and descriptions thereof).

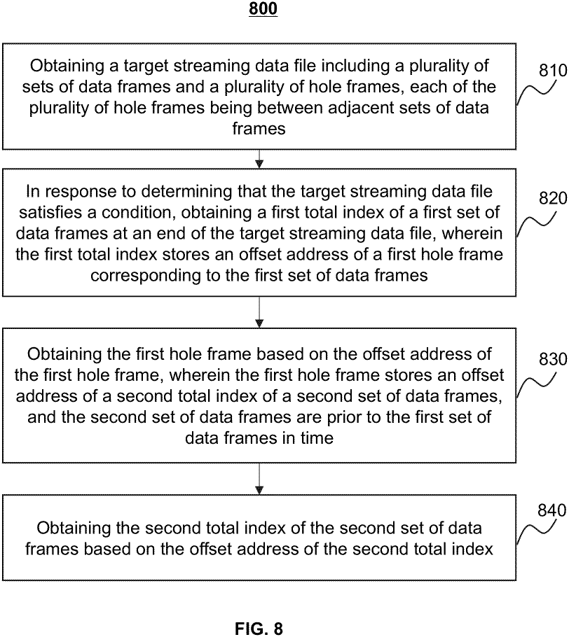

The establishing unit 403 may be configured to establish a streaming data file. In some embodiments, the establishing unit 403 may establish a second streaming data file including a second set of data frames. In some embodiments, the establishing unit 403 may establish a target streaming data file by adding a second set of data frames into a streaming data file based on a hole frame. More descriptions for establishing the target streaming data file may be found elsewhere in the present disclosure (e.g., FIGS. 5, 6, 9-11, and descriptions thereof). In some embodiments, the establishing unit 403 may establish a target streaming data file by adding a second streaming data file into a first streaming data file through a hole frame. More descriptions for establishing the target streaming data file may be found elsewhere in the present disclosure (e.g., FIGS. 7, 9-11, and descriptions thereof).

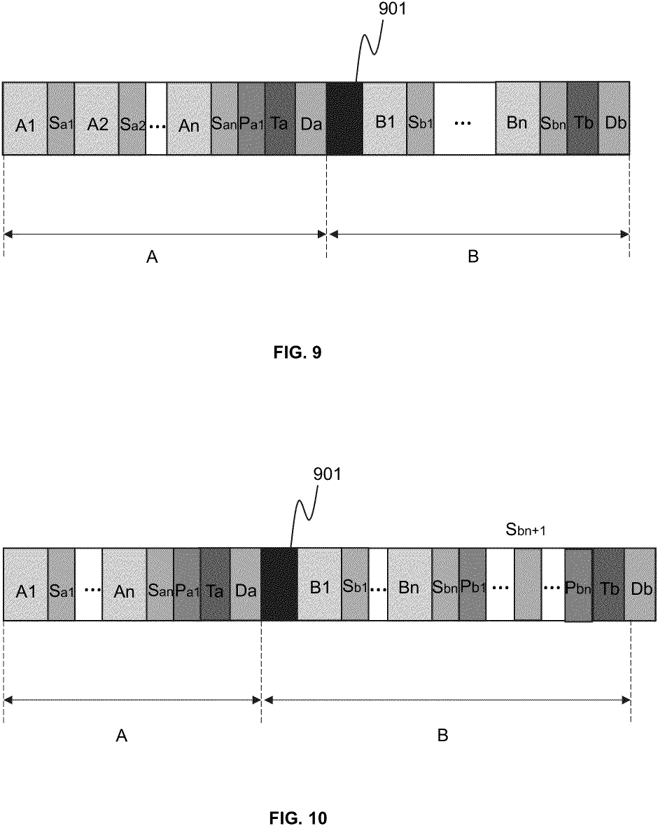

The file obtaining unit 404 may be configured to obtain a data file. For example, the file obtaining unit 404 may obtain a target streaming data file including a plurality of sets of data frames and a plurality of hole frames. More descriptions for obtaining the target streaming data file may be found elsewhere in the present disclosure (e.g., operation 810 in FIG. 8, and descriptions thereof).

The index obtaining unit 405 may be configured to obtain an index (e.g., a total index, a primary index, a secondary index). For example, in response to determining that a target streaming data file satisfies a condition, the index obtaining unit 405 may obtain a first total index of a first set of data frames at an end of the target streaming data file. As another example, the index obtaining unit 405 may obtain a second total index of a second set of data frames based on an offset address of the second total index. More descriptions for obtaining the index may be found elsewhere in the present disclosure (e.g., operation 820 and operation 840 in FIG. 8, and descriptions thereof).

The frame obtaining unit 406 may be configured to obtain a frame (e.g., a hole frame, a data frame). For example, the frame obtaining unit 406 may obtain a first hole frame based on an offset address of the first hole frame. More descriptions for obtaining the first hole frame may be found elsewhere in the present disclosure (e.g., operation 830 in FIG. 8, and descriptions thereof).

The modules in the processing device 112 may be connected to or communicated with each other via a wired connection or a wireless connection. The wired connection may include a metal cable, an optical cable, a hybrid cable, or the like, or any combination thereof. The wireless connection may include a local area network (LAN), a wide area network (WAN), a Bluetooth, a ZigBee, a near field communication (NFC), or the like, or any combination thereof. Two or more of the modules may be combined into a single module, and any one of the modules may be divided into two or more units. In some embodiments, one or more modules may be combined into a single module. For example, the storing module 410 and the retrieving module 420 may be combined as a single module which may both store data and retrieve data. In some embodiments, one or more units may be combined into a single unit. For example, the file obtaining unit 404, the index obtaining unit 405, and the frame obtaining unit 406 may be combined as a single unit. As another example, the generation unit 402 and the establishing unit 403 may be combined as a single unit. In some embodiments, one or more modules and/or one or more units may be added or omitted.

FIG. 5 is a flowchart illustrating an exemplary process for storing data according to some embodiments of the present disclosure. The process 500 may be executed by the data system 100. For example, the process 500 may be stored in the storage device 140 and/or the storage (e.g., the storage 390) as a form of instructions, and invoked and/or executed by the processing device 112 (e.g., the processor 220 of the computing device 200 as illustrated in FIG. 2, the CPU 340 of the mobile device 300 as illustrated in FIG. 3, one or more modules and/or units as illustrated in FIGS. 4A-4C). The operations of the illustrated process presented below are intended to be illustrative. In some embodiments, the process 500 may be accomplished with one or more additional operations not described and/or without one or more of the operations discussed. Additionally, the order in which the operations of the process 500 as illustrated in FIG. 5 and described below is not intended to be limiting.

In 510, the processing device 112 (e.g., the obtaining unit 401) may obtain a streaming data file including a first set of data frames.

In some embodiments, the first set of data frames may include one or more data frames. As used herein, a data frame refers to an image or a discrete unit within a video. In some embodiments, the data frame may include an intra frame (also referred to as an I frame), a predicted frame (also referred to as a P-frame), a bi-directionally predicted frame (also referred to as a B-frame), or the like, or any combination thereof. In some embodiments, the first set of data frames may be continuous in time. As used herein, “a data frame A and a data frame B being continuous in time” refers that a time difference between a first time point corresponding to the data frame A and a second time point corresponding to the data frame B is less than a threshold. As used herein, “a time point corresponding to a data frame” refers to a time point when the data frame is acquired (e.g., by an image acquisition device). For example, the first set of data frames may be consecutive data frames in a video. In some embodiments, at least two data frames in the first set of data frames may be not continuous in time. For example, the first set of data frames may include multiple portions of data. Data frames in each of the multiple portions may be continuous in time. The last data frame and the first data frame in two portions may be not continuous in time.

In some embodiments, the processing device 112 may obtain the streaming data file from an image acquisition device periodically (e.g., per second, per 2 seconds, per 5 seconds, per 10 seconds) or in real time. In some embodiments, during the capturing of the first set of data frames, the image acquisition device may transmit the first set of data frames to a storage device (e.g., the storage device 140) periodically (e.g., per second, per 2 seconds, per 5 seconds, per 10 seconds) or in real time (e.g., via the network 150). Further, the processing device 112 may access the storage device 140 and retrieve the first set of data frames.

In 520, in response to determining that the streaming data file satisfies one or more conditions, the processing device 112 (e.g., the generation unit 402) may generate a hole frame storing an offset address of the streaming data file.

In some embodiments, the steaming data file may satisfy the one or more conditions in response to determining that the first set of data frames in the streaming data file is not continuous with a second set of data frames to be added into the streaming data file. In some embodiments, the steaming data file may satisfy the one or more conditions in response to determining that the streaming data file is closed, the streaming data file is then reopened, a storage time of the streaming data file is less than a time threshold, or the like, or any combination thereof. For example, the steaming data file may satisfy the one or more conditions in response to determining that the streaming data file is closed, and the streaming data file is then reopened. As another example, the steaming data file may satisfy the one or more conditions in response to determining that the streaming data file is closed, the streaming data file is then reopened, and the storage time of the streaming data file is less than the time threshold.

As used herein, a storage time of a data file refers to a total storage time of one or more data frames in the data file. In some embodiments, the storage time of the data file may be a duration of adding the one or more data frames into the data file. For example, if a data file includes a plurality of continuous data frames, the first data frame of the plurality of continuous data frames corresponds to a first time point and the last data frame of the plurality of continuous data frames corresponds to a second time point, a time difference between the second time point and the first time point may be determined as the storage time of the data file. As another example, if a data file includes a first portion of data and a second portion of data, data frames in each of the two portions is continuous in time, and the last data frame in the first portion and the first data frame in the second portion are not continuous in time, a sum of a time difference between a time point corresponding to the first data frame in the first portion and a time point corresponding to the last data frame in the first portion, and a time difference between a time point corresponding to the first data frame in the second portion and a time point corresponding to the last data frame in the second portion, may be determined as the storage time of the data file.

In some embodiments, the time threshold may be a maximum storage time of the streaming data file. For example, when data frames are added and/or stored in a streaming data file, a storage time of the streaming data file may be determined (substantially) in real time. The data frames may be added and/or stored in the streaming data file until the storage time of the streaming data file is equal to or greater than the time threshold. When the storage time of the streaming data file is equal to or greater than the time threshold, the streaming data file may be closed, another streaming data file may be established, and subsequent data frames may be added and/or stored in the another streaming data file. The time threshold may be manually set by a user of the data system 100, or be determined by one or more components (e.g., the processing device 112) of the data system 100 according to different situations. Merely by way of example, the time threshold may be 30 minutes, 60 minutes, 120 minutes, or the like.

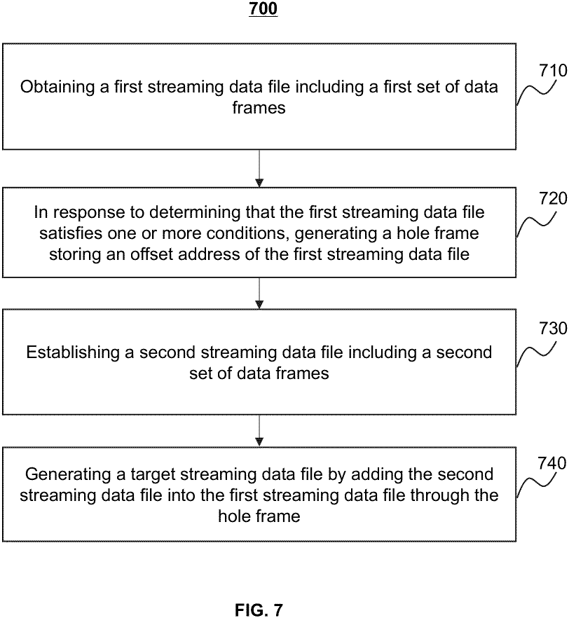

The hole frame may store the offset address of the streaming data file, hole time information, or the like, or any combination thereof. As used herein, an offset address is used to describe a location of a subject (e.g., a frame, a data file) compared to another location. For example, an offset address of the subject (e.g., a frame, a data file) refers to the number of address locations added to a base address in order to get to a specific absolute address of the subject. In some embodiments, the offset address of the streaming data file may include an offset address of a first total index, an offset address of a first description of the streaming data file, or the like, or any combination thereof. More descriptions of the first total index and the first description of the streaming data file may be found elsewhere in the present disclosure (e.g., FIG. 6 and descriptions thereof).

The hole time information may indicate a time interval between two sets of discontinuous data frames (e.g., the first set of data frames and the second set of data frames). For example, the hole time information may indicate a time interval between the last data frame in the first set of data frames and the first data frame in the second set of data frames. In some embodiments, the hole time information may include one or more time points corresponding to the one or more conditions (e.g., a time point when the streaming data file is closed, a time point when the streaming data file is reopened), one or more time points corresponding to one or more data frames in the first set of data frames and/or one or more data frames in the second set of data frames (e.g., a time point corresponding to a data frame in the first set of data frames added immediately prior to the hole frame, a time point corresponding to a data frame in the second set of data frames added immediately after the hole frame), or the like, or any combination thereof.

In some embodiments, the processing device 112 may add the hole frame after the first set of data frames. More descriptions for adding the hole frame may be found elsewhere in the present disclosure (e.g., FIGS. 6, 9, and 10, and descriptions thereof).

In 530, the processing device 112 (e.g., the establishing unit 403) may establish a target streaming data file by adding a second set of data frames into the streaming data file based on the hole frame.

In some embodiments, the processing device 112 may establish the target streaming data file by adding the second set of data frames after the hole frame. Since the hole frame stores the hole time information associated with the first set of data frames and the second set of data frames, by adding the hole frame after the first set of data frames and before the second set of data frames, the first set of data frames, the hole frame, and the second set of data frames may be continuous in time.

In some embodiments, the second set of data frames may be streaming data. As used herein, streaming data refers to data that is continuously generated. In some embodiments, the second set of data frames may include one or more data frames. In some embodiments, the processing device 112 may add the second set of data frames until a storage time of the target streaming data file is equal to or greater than the time threshold. For example, when the storage time of the target streaming data file is equal to or greater than the time threshold, another streaming data file may be established, and the data frames may be added and/or stored in the another streaming data file. In some embodiments, the processing device 112 may add the second set of data frames until the target streaming data file is closed.

In some embodiments, the processing device 112 may repeatedly perform operations 510-530. For example, the processing device 112 may update the streaming data file in operation 510 using the target streaming data file, in response to determining that the target streaming data file (i.e., updated streaming data file) satisfies one or more conditions, the processing device 112 may generate another hole frame storing an offset address of the target streaming data file, and update the target streaming data file by adding another set of data frame into the target streaming data file based on the another hole frame. The hole frame added in previous may also be referred to as a previous hole frame.

According to some embodiments of the present disclosure, by using the hole frame to store the hole time information, the target streaming data file may be established based on the first set of data frames, the hole frame, and the second set of data frames, which may facilitate the adding and reading process of the streaming data, and no additional index file is required to store the hole time information.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in process 500. For example, an operation for determining whether the target streaming data file satisfies one or more conditions may be added after operation 530. As another example, an operation for adding at least one index after the hole frame may be added in process 500.

FIG. 6 is a flowchart illustrating an exemplary process for storing data according to some embodiments of the present disclosure. The process 600 may be executed by the data system 100. For example, the process 600 may be stored in the storage device 140 and/or the storage (e.g., the storage 390) as a form of instructions, and invoked and/or executed by the processing device 112 (e.g., the processor 220 of the computing device 200 as illustrated in FIG. 2, the CPU 340 of the mobile device 300 as illustrated in FIG. 3, one or more modules and/or units as illustrated in FIGS. 4A-4C). The operations of the illustrated process presented below are intended to be illustrative. In some embodiments, the process 600 may be accomplished with one or more additional operations not described and/or without one or more of the operations discussed. Additionally, the order in which the operations of the process 600 as illustrated in FIG. 6 and described below is not intended to be limiting.

In 610, the processing device 112 (e.g., the obtaining unit 401) may obtain a streaming data file including a first set of data frames.

Operation 610 may be performed in a similar manner as operation 510 as described in connection with FIG. 5, the descriptions of which are not repeated here.

In 620, in response to determining that the streaming data file satisfies a first condition, the processing device 112 (e.g., the generation unit 402) may add a first total index and a first description of the streaming data file at an end of the streaming data file.

In some embodiments, the steaming data file may satisfy the first condition in response to determining that the streaming data file is closed. In some embodiments, in response to determining that the streaming data file is closed, the first total index and the first description of the streaming data file may be added in the streaming data file after the first set of data frames. In some embodiments, the first total index may store index information of a target frame (e.g., an I-frame) in the first set of data frames, an offset address of a previous hole frame (if exists) added prior to the first total index in the streaming data file, or the like, or any combination thereof. For example, if the streaming data file includes a plurality of first data frames, a first hole frame added after the plurality of first data frames, and a plurality of second data frames added after the first hole frame, when the streaming data file is closed, the processing device 112 may add the first total index after the plurality of second data frame, and the first total index may store index information of one or more I-frames in the plurality of first data frames and the plurality of second data frame, and an offset address of the first hole frame in the streaming data file.

In some embodiments, the first description of the streaming data file may store a storage time of the streaming data file (e.g., a total storage time of the first set of data frames), a time point corresponding to each data frame of the first set of data frames, or the like, or any combination thereof.

In 630, in response to determining that the streaming data file satisfies a second condition, the processing device 112 (e.g., the generation unit 402) may add a hole frame after the first file description in the streaming data file.

In some embodiments, the steaming data file may satisfy the second condition in response to determining that the streaming data file is opened after the streaming data file is closed. In some embodiments, the steaming data file may satisfy the second condition in response to determining that the streaming data file is opened after the streaming data file is closed, and a storage time of the streaming data file is less than a time threshold. For example, in response to determining that the streaming data file is opened after the streaming data file is closed, and the storage time of the streaming data file is less than the time threshold, the processing device 112 may add the hole frame after the first file description in the streaming data file.

In 640, the processing device 112 (e.g., the generation unit 402) may add at least one index after the hole frame according to at least one time period. The at least one index may store at least one of index information of a target frame in the second set of data frames, or an offset address of the hole frame in the target streaming data file.

In some embodiments, the at least one index may include a primary index, a secondary index, or the like. The at least one time period may include a first time period corresponding to the secondary index, a second time period corresponding to the primary index, or the like. In some embodiments, the first time period may be less than the second time period. The first time period and the second time period may be manually set by a user of the data system 100, or be determined by one or more components (e.g., the processing device 112) of the data system 100 according to different situations. For example, the first time period may be 2 seconds, 5 seconds, 10 seconds, or the like. The second time period may be 60 seconds, 90 seconds, 120 seconds, or the like.

In some embodiments, the processing device 112 may add at least one secondary index after the hole frame according to the first preset time period. For illustration purposes, if the first preset time period is 2 seconds, the secondary index may be added after the hole frame every 2 seconds. The secondary index may store the index information of the target frame in the second set of data frames added in the corresponding first preset time period, an offset address of a previous primary index (if exists) added prior to the at least one secondary index, or the like, or any combination thereof.

In some embodiments, the processing device 112 may add at least one primary index after the hole frame according to the second time period. For illustration purposes, if the second time period is 60 seconds, the primary index may be added after the hole frame every 60 seconds. The primary index may store an offset address of at least one previous secondary index added prior to the primary index in the corresponding second time period, the offset address of the hole frame in the target streaming data file, or the like, or any combination thereof.

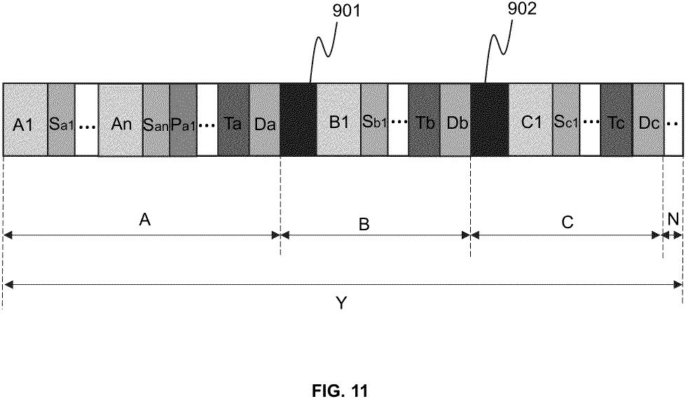

In some embodiments, a preset number of secondary indexes added after the hole frame may store the offset address of the hole frame in the streaming data file. The preset number may be manually set by a user of the data system 100, or be determined by one or more components (e.g., the processing device 112) of the data system 100 according to different situations. In some embodiments, the secondary index(es) added before the first added primary index after the hole frame may store the offset address of the hole frame in the streaming data file. More descriptions for adding the secondary index and the primary index may be found elsewhere in the present disclosure (e.g., FIGS. 9, 10, and descriptions thereof).

In 650, the processing device 112 (e.g., the establishing unit 403) may establish a target streaming data file by adding second set of data frames into the streaming data file based on the hole frame.

Operation 650 may be performed in a similar manner as operation 530 as described in connection with FIG. 5, the descriptions of which are not repeated here.

In 660, in response to determining that the target streaming data file satisfies the first condition, the processing device 112 (e.g., the generation unit 402) may add a second total index and a second description of the target streaming data file at an end of the target streaming data file.

In some embodiments, the target steaming data file may satisfy the first condition in response to determining that the target streaming data file is closed. For example, in response to determining that the target streaming data file is closed, the processing device 112 may add the second total index and the second description of the target streaming data file after the second set of data frames. In some embodiments, the target steaming data file may satisfy the first condition in response to determining that a storage time of the target streaming data file is equal to or greater than the time threshold. For example, in response to determining that the storage time of the target streaming data file is equal to or greater than the time threshold, the processing device 112 may add the second total index and the second description of the target streaming data file after the second set of data frames.

The second total index may store index information of a target frame (e.g., an I frame) in the second set of data frames, the offset address of the hole frame in the target streaming data file, or the like. The second description of the target streaming data file may store a storage time of the target streaming data file, a storage time of the second set of data frames, a time point corresponding to each data frame of the second set of data frames, or the like, or any combination thereof.

In some embodiments, operations 610-650 may be repeated until the storage time of the target streaming data file is equal to or greater than the time threshold. For example, after operation 660, the processing device 112 may determine whether the target streaming data file satisfies the second condition. In response to determining that the target streaming data file satisfies the second condition, the processing device 112 may add a second hole frame after the second file description in the target streaming data file. For example, in response to determining that the target streaming data file is opened after the target streaming data file is closed, and the storage time of the target streaming data file is less than the time threshold, the processing device 112 may add the second hole frame after the second file description in the target streaming data file. Further, the processing device 112 may establish a second target streaming data file by adding a third set of data frames into the target streaming data file based on the second hole frame.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, a hole index may be added at an end of the target streaming data file. The hole index may store index information of all hole frames in the target streaming data file. In some embodiments, one or more operations may be added or omitted in process 600. For example, operation 660 may be omitted. In some embodiments, two or more operations may be performed simultaneously. For example, operations 640 and 650 may be performed simultaneously.

FIG. 7 is a flowchart illustrating an exemplary process for storing data according to some embodiments of the present disclosure. The process 700 may be executed by the data system 100. For example, the process 700 may be stored in the storage device 140 and/or the storage (e.g., the storage 390) as a form of instructions, and invoked and/or executed by the processing device 112 (e.g., the processor 220 of the computing device 200 as illustrated in FIG. 2, the CPU 340 of the mobile device 300 as illustrated in FIG. 3, one or more modules and/or units as illustrated in FIGS. 4A-4C). The operations of the illustrated process presented below are intended to be illustrative. In some embodiments, the process 700 may be accomplished with one or more additional operations not described and/or without one or more of the operations discussed. Additionally, the order in which the operations of the process 700 as illustrated in FIG. 7 and described below is not intended to be limiting.

In 710, the processing device 112 (e.g., the obtaining unit 401) may obtain a first streaming data file including a first set of data frames.

Operation 710 may be performed in a similar manner as operation 510 as described in connection with FIG. 5, the descriptions of which are not repeated here.

In 720, in response to determining that the first streaming data file satisfies one or more conditions, the processing device 112 (e.g., the generation unit 402) may generate a hole frame storing an offset address of the first streaming data file.

In some embodiments, the first streaming data file may satisfy the one or more conditions in response to determining that the first set of data frames in the first streaming data file is not continuous with a second set of data frames to be added into the first streaming data file. For example, the first streaming data file may satisfy the one or more conditions in response to determining that the first streaming data file is closed, the first streaming data file is then reopened, and a storage time of the first streaming data file is less than a time threshold. As another example, the first streaming data file may satisfy the one or more conditions in response to determining that the first streaming data file is closed, and the first streaming data file is then reopened.

Operation 720 may be performed in a similar manner as operation 520 as described in connection with FIG. 5, the descriptions of which are not repeated here.

In 730, the processing device 112 (e.g., the establishing unit 403) may establish a second streaming data file including a second set of data frames.

In some embodiments, the processing device 112 may establish the second streaming data file by adding the second set of data frames after the hole frame. In some embodiments, the second streaming data file may include the hole frame and the second set of data frames. By adding the hole frame after the first set of data frames and before the second set of data frames, the first set of data frames, the hole frame, and the second set of data frames may be continuous in time. That is, the first streaming data file and the second streaming data file may be continuous in time.

In some embodiments, the second set of data frames may be added in the second streaming data file until the second streaming data file is closed. In some embodiments, the second set of data frames may be added in the second streaming data file until a storage time of the first streaming data file and the second streaming data file is equal to or greater than the time threshold. If the storage time of the first streaming data file and the second streaming data file is equal to or greater than the time threshold, the second streaming data file may be closed.

In 740, the processing device 112 (e.g., the establishing unit 403) may generate a target streaming data file by adding the second streaming data file into the first streaming data file through the hole frame.

In some embodiments, the processing device 112 may generate the target streaming data file by combining the first streaming data file and the second streaming data file based on the hole frame. For example, the processing device 112 may generate the target streaming data file by adding the hole frame and the second set of data frames after the first set of data frames. More descriptions for generating the target streaming data file may be found elsewhere in the present disclosure (e.g., FIGS. 9-11, and descriptions thereof).

In some embodiments, the processing device 112 may repeatedly perform operations 710-740. For example, the processing device 112 may update the first streaming data file in operation 710 using the target streaming data file, in response to determining that the target streaming data file (i.e., updated streaming data file) satisfies one or more conditions, the processing device 112 may generate another hole frame storing an offset address of the target streaming data file, and update the target streaming data file by adding another streaming data file into the target streaming data file based on the another hole frame.

In some embodiments, operations 710-740 may be repeated until a storage time of a plurality of streaming data files (e.g., the first streaming data file, the second streaming data file) is equal to or greater than the time threshold. In some embodiments, after operation 740, in response to determining that the second streaming data file satisfies the one or more conditions, the processing device 112 may generate a second hole frame storing an offset address of the second streaming data file. For example, the second streaming data file may satisfy the one or more conditions in response to determining that the second streaming data file is closed, the second streaming data file is then reopened, and a storage time of the first streaming data file and the second streaming data file is less than the time threshold. The processing device 112 may establish a third streaming data file including a third set of data frames. Further, the processing device 112 may generate the target streaming data file by combining the first streaming data file, the second streaming data file, and the third streaming data file based on the hole frame and the second hole frame.

According to some embodiments of the present disclosure, by combining a plurality of streaming data files (e.g., the first streaming data file, the second streaming data file) into the target streaming data file based on at least one hole frame, a total number of streaming data files may be reduced, and data management pressure of the data system 100 (e.g., a cloud storage system) may be reduced. Furthermore, the read and write performance of a continuous streaming data file (e.g., the target streaming data file) may be higher than that of a plurality of small streaming data files.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, operation 730 may be performed before operation 720. For example, in response to determining that the first streaming data file satisfies the one or more conditions, a second streaming data file may be established, and a hole frame may be generated. The hole frame may be added after the first set of data frames, and before the second set of data frames.

In some embodiments, in response to determining that a first streaming data file satisfies a first condition (e.g., the first streaming data file is closed), the processing device 112 may add a first total index and a first description of the first streaming data file at an end of the first streaming data file. In response to determining that the first streaming data file satisfies a second condition (e.g., the first streaming data file is opened after the first streaming data file is closed, and a storage time of the first streaming data file is less than a time threshold), the processing device 112 may establish a second streaming data file. The second streaming data file may include a hole frame and a second set of data frames. The second set of data frames may be added after the hole frame. In some embodiments, the processing device 112 may add at least one index after the hole frame according to at least one time period, as described in connection with operation 650. In response to determining that the second streaming data file satisfies the first condition (e.g., the second streaming data file is closed), the processing device 112 may add a second total index and a second description of the second streaming data file at an end of the second streaming data file. Further, the processing device 112 may generate a target streaming data file by combining the first streaming data file and the second streaming data file based on the hole frame. For example, the processing device 112 may added the hole frame after the first file description in the first streaming data file to combine the first streaming data file and the second streaming data file.

FIG. 8 is a flowchart illustrating an exemplary process for retrieving data according to some embodiments of the present disclosure. The process 800 may be executed by the data system 100. For example, the process 800 may be stored in the storage device 140 and/or the storage (e.g., the storage 390) as a form of instructions, and invoked and/or executed by the processing device 112 (e.g., the processor 220 of the computing device 200 as illustrated in FIG. 2, the CPU 340 of the mobile device 300 as illustrated in FIG. 3, one or more modules and/or units as illustrated in FIGS. 4A-4C). The operations of the illustrated process presented below are intended to be illustrative. In some embodiments, the process 800 may be accomplished with one or more additional operations not described and/or without one or more of the operations discussed. Additionally, the order in which the operations of the process 800 as illustrated in FIG. 8 and described below is not intended to be limiting.

In 810, the processing device 112 (e.g., the file obtaining unit 404) may obtain a target streaming data file including a plurality of sets of data frames and a plurality of hole frames. Each of the plurality of hole frames may be between adjacent sets of data frames. For example, one of the plurality of hole frames between adjacent sets of data frames may be between a last data frame in a set of data frames and a first data frame in another set of data frames that is adjacent to the set of data frames. Each of the plurality of sets of data frames may have continuous data frames.

In some embodiments, the target streaming data file may be established by adding one or more sets of data frames into a first streaming data file based on the plurality of hole frames according to process 500 or process 600, as described in FIGS. 5 and 6. In some embodiments, each of the plurality of sets of data frames may be stored in a streaming data file, and the target streaming data file may be established based on a plurality of streaming data files and the plurality of hole frames according to process 700, as described in FIG. 7.

In some embodiments, the target streaming data file may be stored in a storage device (e.g., the storage device 140) of the data system 100, and the processing device 112 may access the storage device (e.g., the storage device 140) and obtain the target streaming data file when the processing device 112 retrieves data from the target streaming data file.

In 820, in response to determining that the target streaming data file satisfies a condition, the processing device 112 (e.g., the index obtaining unit 405) may obtain a first total index of a first set of data frames at an end of the target streaming data file.

In some embodiments, the target streaming data file may satisfy the condition in response to determining that no data is added into the target streaming data file. For example, in response to determining that no data frame is added into the target streaming data file, the processing device 112 may obtain the first total index of the first set of data frames at the end of the target streaming data file. The first set of data frames may be the last set of data frames in the target streaming data file. The first total index may store an offset address of a first hole frame corresponding to the first set of data frames. More descriptions of a total index of a set of data frames may be found elsewhere in the present disclosure (e.g., FIG. 6 and descriptions thereof).

In 830, the processing device 112 (e.g., the frame obtaining unit 406) may obtain the first hole frame based on the offset address of the first hole frame.

In some embodiments, the first hole frame may be between the first set of data frames and a second set of data frames. The second set of data frames may be prior to the first set of data frames in time. The first hole frame may store an offset address of a second total index of the second set of data frames.

In 840, the processing device 112 (e.g., the index obtaining unit 405) may obtain the second total index of the second set of data frames based on the offset address of the second total index.

In some embodiments, the second total index may store an offset address of a second hole frame corresponding to the second set of data frames. In some embodiments, the processing device 112 may repeatedly perform operations 810-840 until a plurality of total indexes of the plurality of sets of data frames, and a plurality of hole frames corresponding to the plurality of sets of data frames are obtained. For example, after operation 840, the processing device 112 may obtain the second hole frame based on the offset address of the second hole frame. The second hole frame may store an offset address of a third total index of a third set of data frames. The second hole frame may be between the second set of data frames and the third set of data frames. The third set of data frames may be prior to the second set of data frames in time. The processing device 112 may obtain the third total index of the third set of data frames based on the offset address of the third total index.

In some embodiments, after the plurality of total indexes of the plurality of sets of data frames are obtained, the processing device 112 may retrieve data based on the plurality of total indexes of the plurality of sets of data frames.

In some embodiments, in response to determining that the target streaming data file does not satisfy the condition, the processing device 112 may obtain a target index corresponding to a target position in the first set of data frames. For example, in response to determining that data is added into the target streaming data file, the processing device 112 may obtain a target index corresponding to a target position in the first set of data frames. In some embodiments, the target position may be a position of a data frame being added into the target streaming data file. The target index corresponding to the target position in the first set of data frames may be an index (e.g., a secondary index) that is closest to the target position in the first set of data frames. The target index may store the offset address of the first hole frame corresponding to the first set of data frames.

The processing device 112 may then obtain the first hole frame based on the target index. In some embodiments, the target index may be a secondary index. The secondary index may store the offset address of the first hole frame corresponding to the first set of data frames. The processing device 112 may determine whether a primary index corresponding to the target position can be obtained based on the secondary index corresponding to the target position. In response to determining that no primary index corresponding to the target position can be obtained based on the secondary index corresponding to the target position, the processing device 112 may obtain the offset address of the first hole frame corresponding to the first set of data frames based on the secondary index corresponding to the target position in the first set of data frames. In some embodiments, “no primary index corresponding to the target position can be obtained based on the secondary index corresponding to the target position” may indicate that a storage time of the first set of data frame is less than a time period corresponding to the primary index, and therefore the primary index has not been generated yet.

In response to determining that a primary index corresponding to the target position can be obtained based on the secondary index corresponding to the target position, the processing device 112 may obtain the primary index corresponding to the target position based on the secondary index corresponding to the target position in the first set of data frames. In some embodiments, “a primary index corresponding to the target position can be obtained based on the secondary index corresponding to the target position” may indicate that a storage time of the first set of data frame is equal to or greater than a time period corresponding to the primary index, and therefore the primary index has been generated. The processing device 112 may obtain the offset address of the first hole frame corresponding to the first set of data frames based on the primary index corresponding to the target position. The processing device 112 may obtain the first hole frame based on the offset address of the first hole frame. The first hole frame may store the offset address of the second total index of the second set of data frames. Further, the processing device 112 may obtain the second total index of the second set of data frames based on the offset address of the second total index.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIGS. 9-11 are schematic diagrams illustrating exemplary processes for storing data according to some embodiments of the present disclosure.

As illustrated in FIGS. 9 and 10, a streaming data file A (e.g., the streaming data file as described in FIGS. 5 and 6, the first streaming data file as described in FIG. 7) may include a first set of data frames (e.g., A₁, A₂, ...., Aₙ), one or more secondary indexes (e.g., Sₐ₁, Sₐ₂, ...., Sₐₙ), and one or more primary indexes (e.g., Pₐ₁). When the first streaming data file A is closed, a first total index Tₐ, and a first description Dₐ of the first streaming data file A may be added at an end of the first streaming data file A (e.g., after the first set of data frames).

In some embodiments, as described in connection with FIGS. 5 and 6, when the first streaming data file A is reopened after the first streaming data file is closed, and a storage time of the first streaming data file A is less than a time threshold (e.g., 60 minutes), a hole frame 901 may be added after the first description Dₐ. The hole frame 901 may store an offset address of the first total index Tₐ, a time point when the first streaming data file A is closed, a time point when the first streaming data file A is reopened, a time point corresponding to the data frame An, a time point corresponding to a data frame B₁ in a second set of data frames, or the like, or any combination thereof. The second set of data frames (e.g., B₁, ...., Bₙ) may be added into the first streaming data file A after the hole frame 901 to update the first streaming data file A. The updated first streaming data file A may also be referred to as a target data file as described in FIGS. 5 and 6.

In some embodiments, as described in connection with FIG. 7, when the first streaming data file A is reopened after the first streaming data file is closed, and a storage time of the first streaming data file A is less than a time threshold (e.g., 60 minutes), the hole frame 901 may be generated. The second set of data frames (e.g., B₁, ...., Bₙ) may be added after the hole frame 901 to establish a second streaming data file B (e.g., the second streaming data file as described in FIG. 7).

In some embodiments, one or more secondary indexes (e.g., S_{b1}, ...., S_{bn}, S_{bn+1}) may be added after the hole frame 901 according to a first preset time period (e.g., 2 seconds). For example, the secondary index may be added every 2 seconds after the hole frame 901. The secondary index may store index information of a target frame (e.g., I frame) in the second set of data frames in the corresponding first preset time period, an offset address of a previous primary index added prior to the secondary index, or the like. For example, as illustrated in FIG. 10, the secondary index S_{bn+1} may store an offset address of the primary index P_{b1} added prior to the secondary index S_{bn+1}.

In some embodiments, one or more primary indexes (e.g., P_{b1}, ...., P_{bn}) may be added after the hole frame 901 according to a second time period (e.g., 60 seconds). For example, the primary index may be added every 60 seconds after the hole frame 901. The primary index may store an offset address of at least one previous secondary index added prior to the primary index, the offset address of the hole frame 901 in the second streaming data file B, or the like. For example, as illustrated in FIG. 10, the primary index P_{b1} may store offset addresses of the secondary index S_{b1}, ...., and the secondary index S_{bn} added prior to the primary index P_{b1}.

In some embodiments, if a storage time of the second streaming data file B is less than the second time period (e.g., 60 seconds), there is no primary index in the second streaming data file B, as illustrated in FIG. 9. In some embodiments, if the storage time of the second streaming data file B is equal to or greater than the second time period (e.g., 60 seconds), one or more primary indexes (e.g., P_{b1}, ...., P_{bn}) may be added in the second streaming data file B, as illustrated in FIG. 10.

In some embodiments, a preset number of secondary indexes after the hole frame may store the offset address of the hole frame 901 in the second streaming data file B. For example, one or more secondary indexes added in a third time period after the hole frame 901 may store the offset address of the hole frame 901 in the second streaming data file B. In some embodiments, the third time period may be the same as the second time period. For example, one or more secondary indexes (e.g., S_{b1}, ...., S_{bn}) added before the primary index P_{b1} may store the offset address of the hole frame 901 in the second streaming data file B, and one or more secondary indexes (e.g., S_{bn+1}) added after the primary index P_{b1} may not store the offset address of the hole frame 901 in the second streaming data file B.

In some embodiments, when the second streaming data file B is closed, a second total index T_{b}, and a second description D_{b} of the second streaming data file B may be added at an end of the second streaming data file B. The second total index T_{b} may store index information of a target frame (e.g., I frame) in the second set of data frames, the offset address of the hole frame 901 in the second streaming data file B, or the like. When the second streaming data file B is reopened, and a storage time of the first streaming data file A and the second streaming data file B is less than the time threshold (e.g., 60 minutes), a hole frame 902 may be generated. A third set of data frames (e.g., C₁) may be added after the hole frame 902 to establish a third streaming data file C. When the third streaming data file C is closed, a third total index T_{c}, and a third description D_{c} of the third streaming data file C may be added at an end of the third streaming data file C. Similarly, if the third streaming data file C is reopened, and a storage time of the first streaming data file A, the second streaming data file B, and the third streaming data file C is less than the time threshold (e.g., 60 minutes), one or more other streaming data files (e.g., a streaming data file N) may be established.

Further, a target streaming data file Y may be generated based on a plurality of streaming data files (e.g., the first streaming data file A, the second streaming data file B, the third streaming data file C...., the streaming data file N), as illustrated in FIG. 11. In some embodiments, the target streaming data file Y may be generated by combining the plurality of streaming data files based on at least one hole frame (e.g., the hole frame 901, the hole frame 902). For example, the hole frame 901 may be added after the first description Dₐ, and the hole frame 902 may be added after the second description D_{b}, to combine the first streaming data file A, the second streaming data file B, and the third streaming data file C, as illustrated in FIG. 11.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for storing data, comprising:
at least one storage device configured to store a set of program instructions; and
at least one processor coupled to the at least one storage device, wherein the at least one processor is configured to execute the program instructions, which causes the system to perform operations including:
obtaining a streaming data file including a first set of data frames; and
in response to determining that the streaming data file satisfies one or more conditions, generating a hole frame storing an offset address of the streaming data file; and establishing a target streaming data file by adding a second set of data frames into the streaming data file based on the hole frame.

2. The system of claim 1, wherein the one or more conditions include a first condition, and the at least one processor is configured to execute the program instructions, which further causes the system to perform operations including:
in response to determining that the streaming data file satisfies the first condition, adding a first total index and a first description of the streaming data file at an end of the streaming data file.

3. The system of claim 2, wherein the steaming data file satisfies the first condition in response to determining that the streaming data file is closed.

4. The system of claim 2, wherein the one or more conditions include a second condition, and the establishing a target streaming data file by adding a second set of data frames into the streaming data file based on the hole frame comprises:
in response to determining that the streaming data file satisfies the second condition, adding the hole frame after the first file description in the streaming data file; and
adding at least one index after the hole frame according to at least one time period, wherein the at least one index stores at least one of index information of a target frame in the second set of data frames, or an offset address of the hole frame in the target streaming data file.

5. The system of claim 4, wherein the at least one index includes a primary index and a secondary index, the at least one time period includes a first time period corresponding to the secondary index, and a second time period corresponding to the primary index, the first time period is less than the second preset time period, and the adding at least one index after the hole frame according to at least one time period comprises:
adding at least one secondary index after the hole frame according to the first preset time period, wherein the at least one secondary index stores the index information of the target frame in the second set of data frames, and an offset address of a previous primary index added prior to the at least one secondary index; and
adding at least one primary index after the hole frame according to the second time period, wherein the at least one primary index stores at least one offset address of at least one previous secondary index added prior to the at least one primary index, and the offset address of the hole frame in the target streaming data file.

6. The system of claim 5, wherein a preset number of secondary indexes in the at least one secondary index after the hole frame stores the offset address of the hole frame in the streaming data file.

7. The system of claim 4, wherein the steaming data file satisfies the second condition in response to determining that that the streaming data file is opened after the streaming data file is closed, and a storage time of the streaming data file is less than a time threshold.

8. The system of claim 2, wherein the at least one processor is configured to execute the program instructions, which causes the system to perform operations including:
in response to determining that the target streaming data file satisfies the first condition, adding a second total index and a second description of the target streaming data file at an end of the target streaming data file, wherein the second total index stores index information of a target frame in the second set of data frames, and the offset address of the hole frame in the target streaming data file.

9. A system for storing data, comprising:
at least one storage device configured to store a set of program instructions; and
at least one processor coupled to the at least one storage device, wherein the at least one processor is configured to execute the program instructions, which causes the system to perform operations including:
obtaining a first streaming data file including a first set of data frames; and
in response to determining that the first streaming data file satisfies one or more conditions, generating a hole frame storing an offset address of the first streaming data file; establishing a second streaming data file including a second set of data frames; and generating a target streaming data file by adding the second streaming data file into the first streaming data file through the hole frame.

10. A system for retrieving data, comprising:
at least one storage device configured to store a set of program instructions; and
at least one processor coupled to the at least one storage device, wherein the at least one processor is configured to execute the program instructions, which causes the system to perform operations including:
obtaining a target streaming data file including a plurality of sets of data frames and a plurality of hole frames, each of the plurality of hole frames being between adjacent sets of data frames; and
in response to determining that the target streaming data file satisfies a condition, obtaining a first total index of a first set of data frames at an end of the target streaming data file, wherein the first total index stores an offset address of a first hole frame corresponding to the first set of data frames; obtaining the first hole frame based on the offset address of the first hole frame, wherein the first hole frame stores an offset address of a second total index of a second set of data frames, and the second set of data frames are prior to the first set of data frames in time; and obtaining the second total index of the second set of data frames based on the offset address of the second total index.

11. The system of claim 10, wherein the target steaming data file satisfies the condition in response to determining that no data is added into the target streaming data file.

12. The system of claim 10, wherein the at least one processor is configured to execute the program instructions, which causes the system to perform operations including:
in response to determining that the target streaming data file does not satisfy the condition, obtaining a target index corresponding to a target position in the first set of data frames; obtaining the first hole frame based on the target index, wherein the first hole frame stores the offset address of the second total index of the second set of data frames; and obtaining the second total index of the second set of data frames based on the offset address of the second total index.

13. The system of claim 12, wherein the target index is a secondary index, and the obtaining the first hole frame based on the target index comprises:
obtaining the offset address of the first hole frame corresponding to the first set of data frames based on the secondary index corresponding to the target position in the first set of data frames.

14. The system of claim 13, wherein the obtaining the offset address of the first hole frame corresponding to the first streaming data file based on the secondary index corresponding to the target position in the first streaming data file comprises:
obtaining a primary index corresponding to the target position based on the secondary index corresponding to the target position in the first set of data frames; and
obtaining the offset address of the first hole frame corresponding to the first set of data frames based on the primary index corresponding to the target position.

15-31. (canceled)

32. The system of claim 9, wherein the one or more conditions include a first condition, and the at least one processor is configured to execute the program instructions, which further causes the system to perform operations including:
in response to determining that the first streaming data file satisfies the first condition, adding a first total index and a first description of the first streaming data file at an end of the first streaming data file.

33. The system of claim 32, wherein the first steaming data file satisfies the first condition in response to determining that the first streaming data file is closed.

34. The system of claim 32, wherein the one or more conditions include a second condition, and the establishing a second streaming data file including a second set of data frames comprises:
in response to determining that the first streaming data file satisfies the second condition, establishing the second streaming data file by adding the second set of data frames after the hole frame.

35. The system of claim 34, wherein the first steaming data file satisfies the second condition in response to determining that that the first streaming data file is opened after the first streaming data file is closed, and a storage time of the first streaming data file is less than a time threshold.

36. The system of claim 34, wherein the at least one processor is configured to execute the program instructions, which further causes the system to perform operations including:
in response to determining that the second streaming data file satisfies the first condition, adding a second total index and a second description of the second streaming data file at an end of the second streaming data file.

37. The system of claim 9, wherein the generating a target streaming data file by adding the second streaming data file into the first streaming data file through the hole frame comprises:
generating the target streaming data file by adding the hole frame and the second set of data frames after the first set of data frames.
